(19) United States
(12) Patent Application Publication
(10) Pub. No.: US 2016/0229274 A1
(43) Pub. Date: Aug. 11, 2016

(54) MODULAR TRUCK CAP

(71) Applicant: Edward COTE, Minot, ME (US)

(72) Inventor: Edward COTE, Minot, ME (US)

(21) Appl. No.: 14/617,829

(22) Filed: Feb. 9, 2015

(51) Int. Cl. B60J 7/02; B60J 10/00

(52) U.S. Cl. CPC B60J 7/022; B60J 10/0091

(57) ABSTRACT

A modular truck cap including at least two segments. The segments are actuated in such a manner so as to drop and slide during retraction and raise and slide during extension thereof. The segments interlock and are arranged so as to provide a flat contiguous surface substantially impervious to wind, rain, snow, and road debris while providing improved aerodynamic characteristics.

### FIELD OF THE INVENTION

The present invention relates to caps for cargo beds of utility vehicles, and more particularly to a telescoping modular cap for the cargo bed of a light truck.

### BACKGROUND OF THE INVENTION

In the area of conventional light trucks commonly known as pickup trucks, a typical feature includes an open cargo bed. The cargo beds include short sides and an open top. Such cargo beds are accessible from the open top and/or through a tailgate or door at the rear of the cargo bed. The cargo bed typically extends from the back of the pickup truck's cab to the tailgate. Numerous cargo bed covers exist in the form of a tonneau cover or a raised cap, and a variety of shapes and sizes are found in the general automotive art.

The basic function of a cargo bed cover is to enclose the open top of the cargo bed so as to protect cargo, tools, or any other contents from the effects of weather, road debris, wind, and also to protect against theft. Often, such conventional cargo bed covers are formed as shells as they consist of a simple outer covering extending laterally between the sides of the bed and lengthwise from the cab to the tailgate. Typically, a tonneau cover extends directly (i.e., horizontally) between the sides of the bed the cargo bed while a raised cap extends between the sides of the cargo bed in some arcuate or protruding manner distanced from the floor of the cargo bed. Cargo bed covers are usually the full size of the cargo bed and larger than the tailgate opening.

Users of pickup trucks often find it desirable for cargo bed covers to be easily removable to either accommodate oversized loads that require greater volume than is available within a covered cargo bed or to allow loading the cargo bed through the open top. Cargo bed covers can be made from materials that can be heavy as they must often be durable due to the use and abuse given to pickup trucks. Such requisite durable construction and related added weight is contrary to ease of installation/removal. Still further, conventional cargo bed covers are often formed in a single piece in the size of the cargo bed to be covered. Accordingly, the installation/removal process requires lifting the entire cargo bed cover into position atop the cargo bed sidewalls. Due to size and weight of the cargo bed cover, this presents difficulty to a user as it is often impossible to be performed by a single person. Once removed, storage of the cargo bed cover becomes a problematic concern.

Oftentimes, the need to cover the cargo bed of a light truck is limited to a small area of the bed. For example, when boxes of small tools, power equipment, or any valuable item(s) need to be sheltered, while still leaving a useful amount of the cargo bed for cargo or other larger items that do not need to be protected or that are otherwise too large to fit within a covering. Some solutions have been to provide sectional tonneau covers or sliding sectional caps. However, these solutions suffer from problems associated with size and weight along with other limitations including uneven surfacing. Such uneven surfaces created by abutting or nesting sections create unwanted detrimental effects in terms of aerodynamic drag on the pickup truck.

It would be advantageous to obviate or mitigate the disadvantages of the aforementioned prior cargo bed covers. Accordingly, it would be desirable to be able to cover only a portion of the cargo bed when needed without the need for storage outside of the pickup truck and without any detrimental effect on aerodynamics. Moreover, it would be desirable to provide a cargo bed cover that is easily installable and removable by a single person and of adjustable length to protect less than all of the cargo bed when desired and to open and uncover some or most of the cargo bed, as desired.

### SUMMARY OF THE INVENTION

According to a first aspect of the invention there is provided a modular truck cap, the cap including at least two segments forming a cover; an actuation mechanism for retracting one of the at least two segments in a downward vertical motion while sliding another of the at least two segments in a horizontal motion.

According to a second aspect of the present invention there is provided a segmented modular truck cap for use in a cargo bed of a pickup truck, said cap including: at least two segments arranged upon a flange and forming a cargo bed cover; an actuation mechanism for actuation of the at least two segments between an extended position and a retracted position, the actuation mechanism capable of selectively retracting one of the at least two segments in a downward vertical motion while sliding another of the at least two segments in a horizontal motion, and extending one of the at least two segments in an upward vertical motion while sliding another of the at least two segments in a horizontal motion.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a modular truck cap according to one embodiment of the present invention shown in an extended position upon a typical pickup truck.

FIG. 2 is a partial cutaway view of the fully extended modular truck cap shown in FIG. 1.

FIGS. 3 through 5 show the modular truck cap of FIG. 2 in a series of retracted positions.

FIG. 6 is lengthwise cutaway view of a fully extended modular truck cap as previously shown in FIG. 1.

FIGS. 7 through 11 show a modular truck cap in a series of positions from fully retracted to fully installed in accordance with a second variation of actuation.

### DETAILED DESCRIPTION

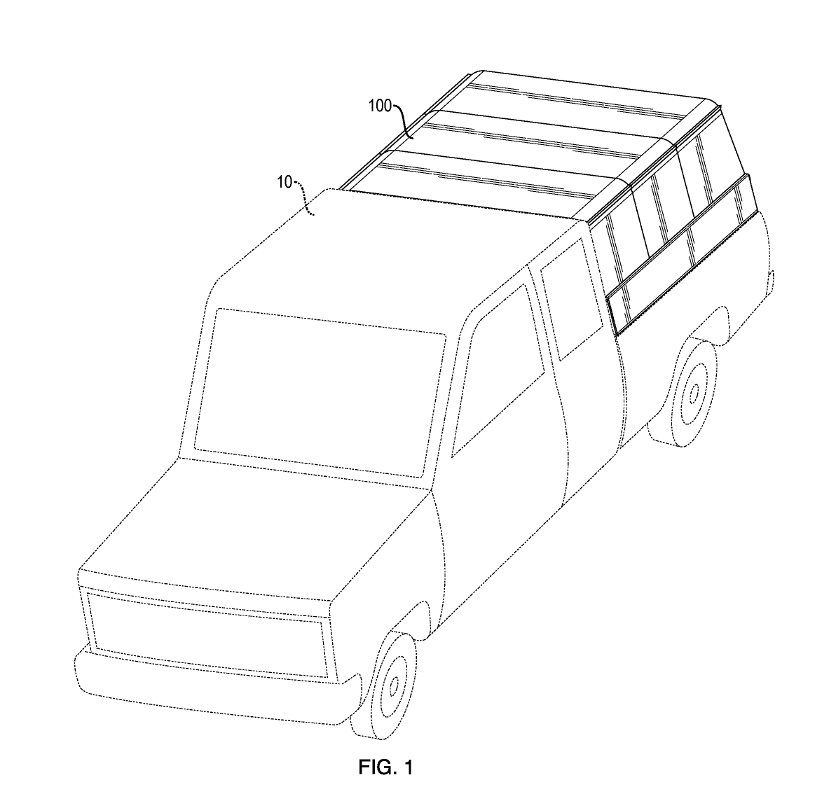

Reference will first be made to FIGS. 1 through 6 which illustrate a modular truck cap according to one embodiment of the present invention.

In FIG. 1 there is provided a modular truck cap 100 shown in place upon the bed of a conventional pickup truck 10. While a conventional pickup truck is shown, it should be understood that the present may be provided for use upon a cargo bed of any substantially similar type of vehicle without straying from the intended scope of the present invention. Indeed, the particular shape of the present inventive modular truck cap 100 may vary according to the corresponding shape of the cargo bed upon which the invention is intended for use. Such variations in shape may include width and height, angle of the sides, and contours of edges and ends. A common inventive feature however is the contiguous outer surface which will be further described herein below.

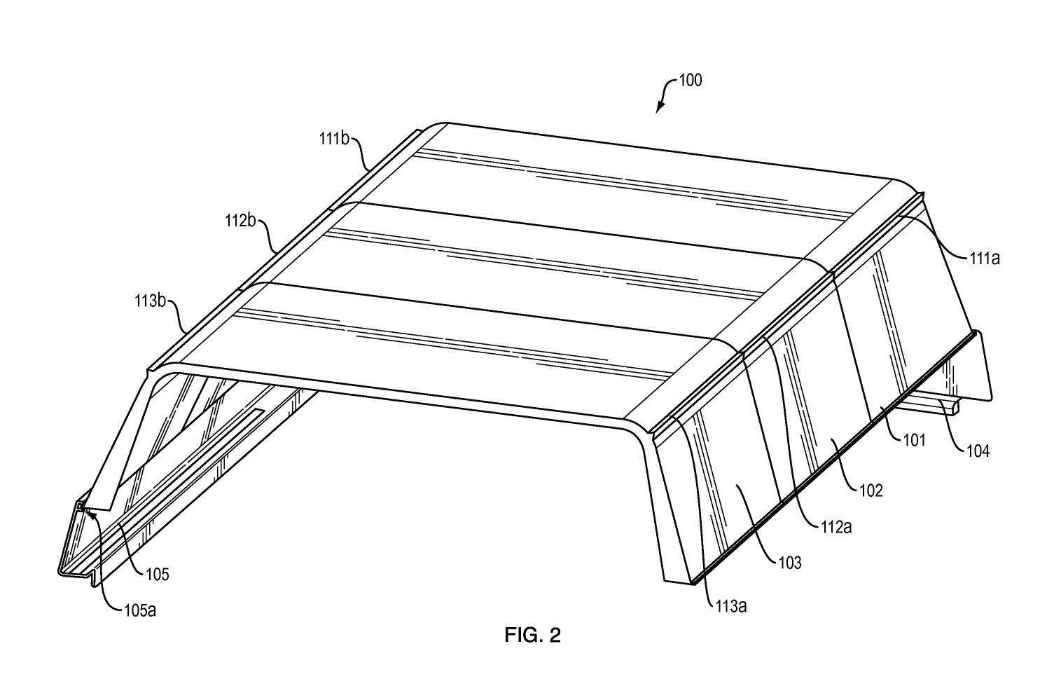

FIG. 2 is a partial cutaway view of the fully extended modular truck cap 100 shown in FIG. 1. Three modular segments 101, 102, 103 are shown. While three segments have been determined to be a well suited configuration for use upon a conventionally sized bed of a pickup truck, it should equally be understood that more than three segments may be possible. One limitation to the number of segments however is the height of the modular truck cap which limits the dropping distance of the segments when retracted in place upon the pickup bed.

With further regard to FIG. 2, the segments 101, 102, 103 are shown in contiguous arrangement upon a side flange 105 and front flange 104. For clarity of illustration, only one side flange is shown though it should be readily apparent that both sides of the segments at their bases are supported by flanges and thus there are two respective side flanges. The side and front flanges serve to provide a continuous interface of the modular truck cap with the top peripheral edges of the given pickup truck's cargo bed. The segments 101, 102, 103 are provided with a rail inset 105a at their direct interface with each of the side flanges. The rail inset provides both a sealing mechanism to prevent, for example, rain penetration, and also allows a smooth horizontal movement of the segments. The contiguous arrangement of the segments also substantially resists, for example, rain penetration into the interior of the modular truck cap 100.

In FIG. 2, there are shown ridges 111a, 111b, 112a, 112b, 113a, and 113b atop each corresponding segment 101, 102, and 103. The ridges have several attributes including functioning as a contiguous rain gutter when the segments are fully deployed as in FIG. 2. As will be described further herein below however, ridges 111a, 111b, 112a, and 112b serve an additional function where segment 102 may be disposed in a sliding manner atop ridges 111a and 111b and, likewise, where segment 103 may be disposed in a sliding manner atop ridges 112a and 112b.

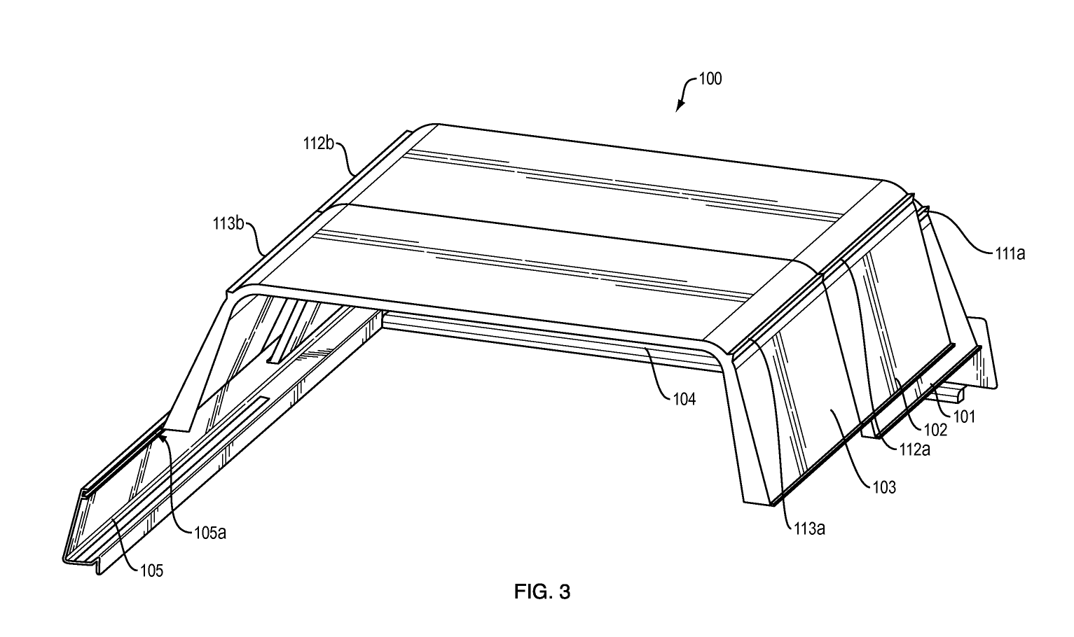

FIGS. 3 through 5 show the modular truck cap 100 in a series of retracted positions relative to the fully extended position as seen in FIG. 2. More specifically, the manner in which retraction occurs segment-by-segment is visible. FIG. 3 shows segment 101 having been retracted in a downward direction. Here, the dropping distance of the segment 101 is limited by the height of the side flanges. That is to say, the segment can only move vertically no further than the distance from the bottom to the top (i.e., the height) of the side flanges. Again, only one side flange 105 shown for illustrative clarity. Once the segment 101 drops downward (i.e., lowers vertically), the remaining two segments 102, 103 are able to slide horizontally along rail insets over the lowered segment 101.

As previously mentioned, sliding ridges are provided atop each segment so as to facilitate horizontal sliding movement of one segment upon another. For example, as can be seen in FIG. 3, ridge 111a is clearly visible as segments 102 and 103 are slid horizontally. Specifically, segment 102 is shown slidingly disposed upon ridge 111a. It should be noted that the same occurs with regard to ridge 111b though this is not visible in the figure as shown. In such instance, the vertical movement of segments would be increased to allow for additional clearance needed for such ridges. This horizontal sliding is accomplished by the user pushing the remaining two segments. Again, only one rail inset 105a is shown for illustrative clarity, though two are provided each atop two corresponding side flanges.

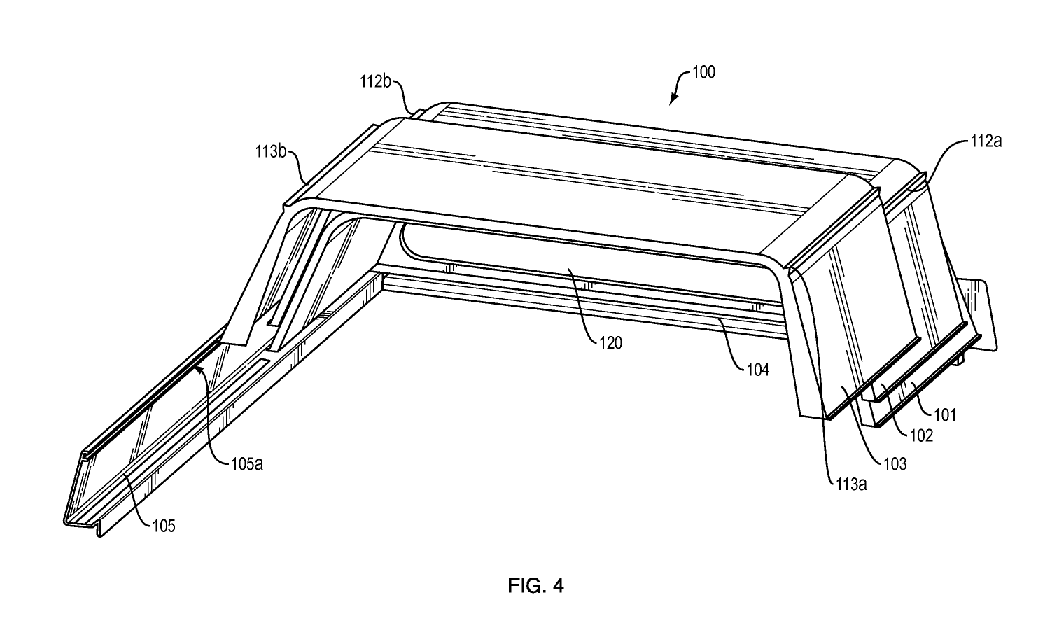

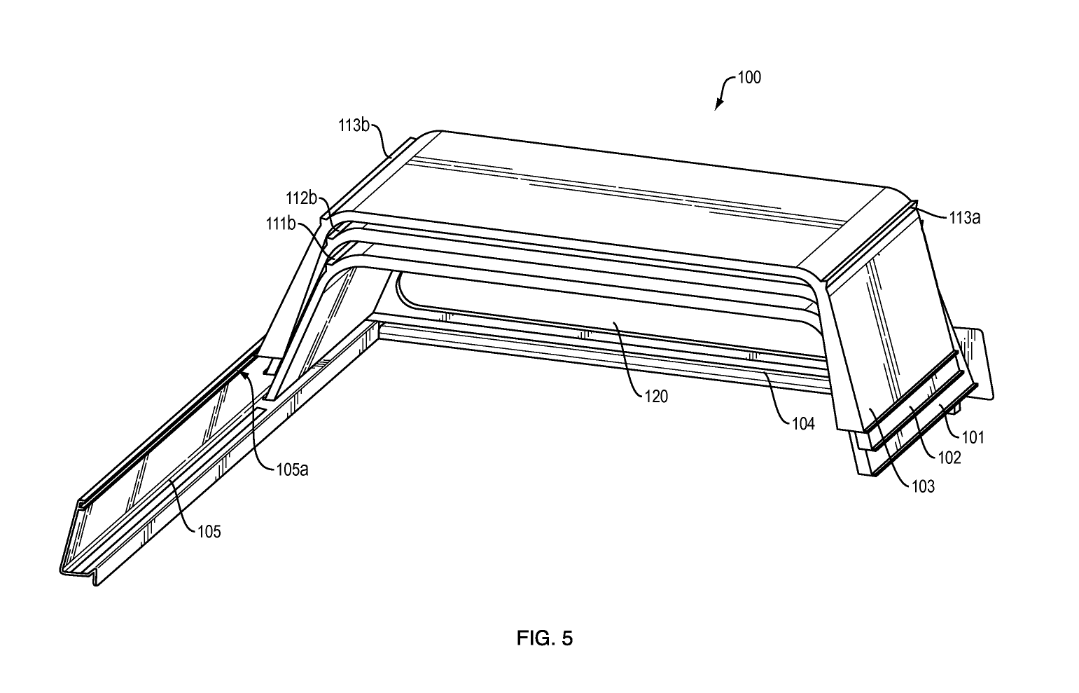

In this drop-and-slide manner, the segments as shown in FIG. 3 provide an area of exposed truck bed where no cover is present. This drop-and-slide movement of retraction continues with regard to FIG. 4. Here, segment 101 is shown with segment 102 slid atop it. Segments 101 and 102 combined both drop downward again so as to allow segment 103 to slide horizontally along rail inset 105a. FIG. 4 shows segment 103 partially retracted while FIG. 5 shows segment 103 fully retracted.

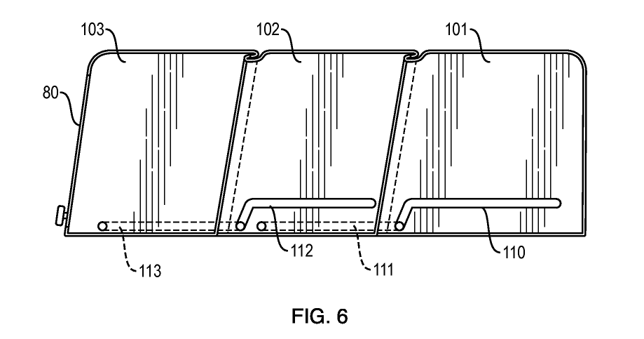

In both FIGS. 4 and 5, front flange 104 can be seen as well as window 120. The window 120 shown is the rear window seen in FIG. 6. It should be readily apparent that such window serves as a door so as to access the interior of the cap when in a fully installed configuration. Such window is removable and storable in an appropriately sized slot at the front of the modular truck cap 100. Storage in such a position helps to eliminate risk of damage or loss if stored remotely from the vehicle. Likewise, storage in such a position provides easy access once the pickup truck, for example, arrives at its location and the user wishes to again install the fully extended modular truck cap.

With regard to FIG. 6 there is shown a lengthwise cutaway view of a fully extended modular truck cap as previously shown in FIG. 1. Here, the contiguous top surface can be seen whereby segment 101 is interlocked in place with segment 102 and, in turn, segment 102 is interlocked in place with segment 103. Such interlocking arrangement helps ensure wind, snow, rain, and road debris are kept out of the interior cargo area confined by the modular truck cap. Moreover, the outer surfaces (i.e., top and sides) of each segment are interlocked in position such that their surfaces are substantially coplanar. This provides a contiguous aspect to surfaces forming the modular truck cap. With regard to the interior space, this means that a substantially uniform space is provided (as opposed to narrowing along its interior length). With regard to the exterior surface, this means that the aesthetics are uniform in terms of a relatively flat outer surface as well as functional aerodynamics are improved in terms of reduced drag by provision of a relatively smooth and flat outer surface.

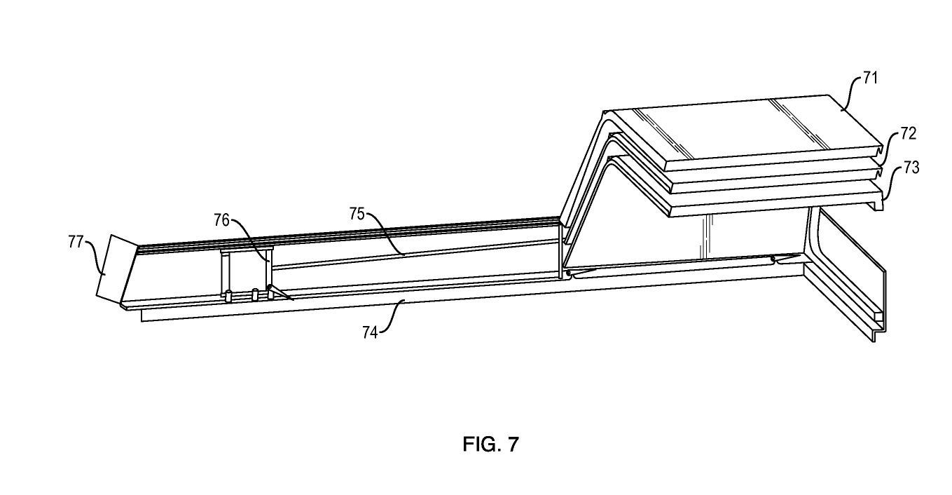

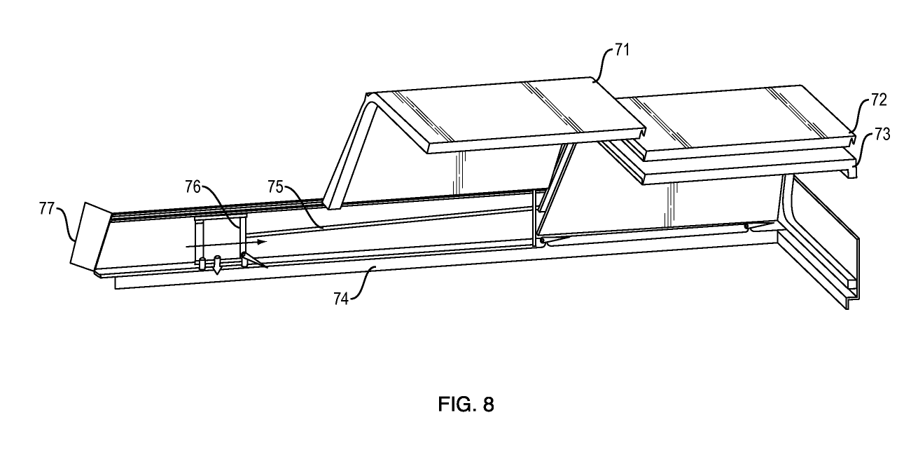

FIG. 6 also shows the inner tracks 110 through 113 by which the drop-and-slide movement is enabled. It should be understood that any particular actuation mechanism may be utilized to facilitate the above described drop-and-slide movement without straying from the intended scope of the present invention. Indeed, a bell crank type of actuation mechanism is illustrated in FIG. 7 through 11 showing one other possible alternative configuration embodying the present invention.

In FIG. 7, segments 71, 72, and 73 are shown in a fully retracted position. Side flange 74 provides both a space for the bell crank mechanism (crank 76 and rod 75 visible) and also height so as to allow dropping placement of segments 72 and 73 as shown. Bell crank devices should be understood to be well known in the mechanical actuation art and as such are not further described in detail herein. An optional end cover 72 may be provided if necessary in order to access the bell crank. During actuation of the bell crank and in reverse order from the previously described retraction in FIGS. 2 through 5, FIG. 8 shows the next step from fully retracted. Here, segment 71 is moved horizontally by way of a user manually pushing such segment. Once the segment 71 is located fully outside of the vertical path of the remaining two segments 72, 73, then such remaining segments are actuated via the bell crank so as to rise from their stored position.

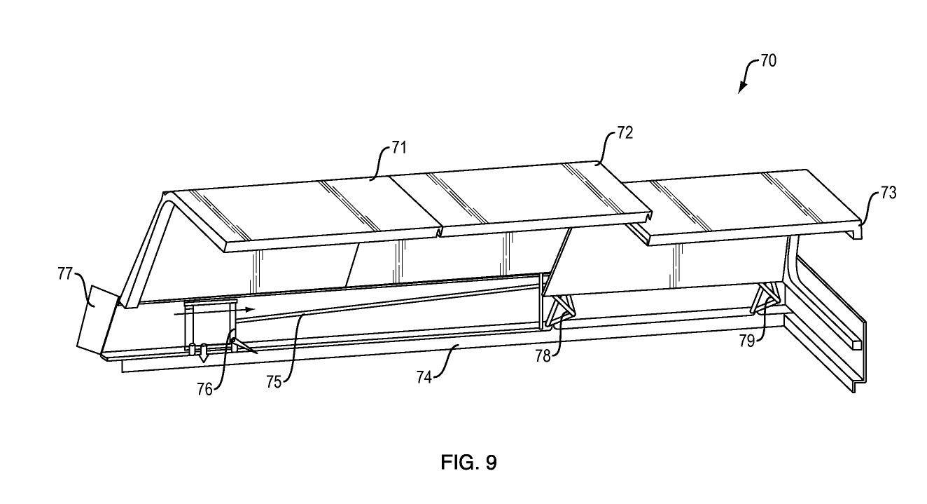

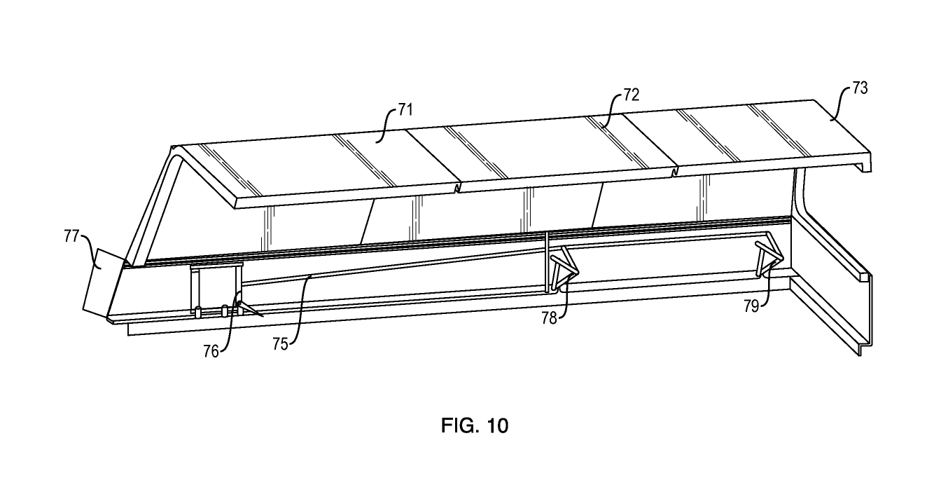

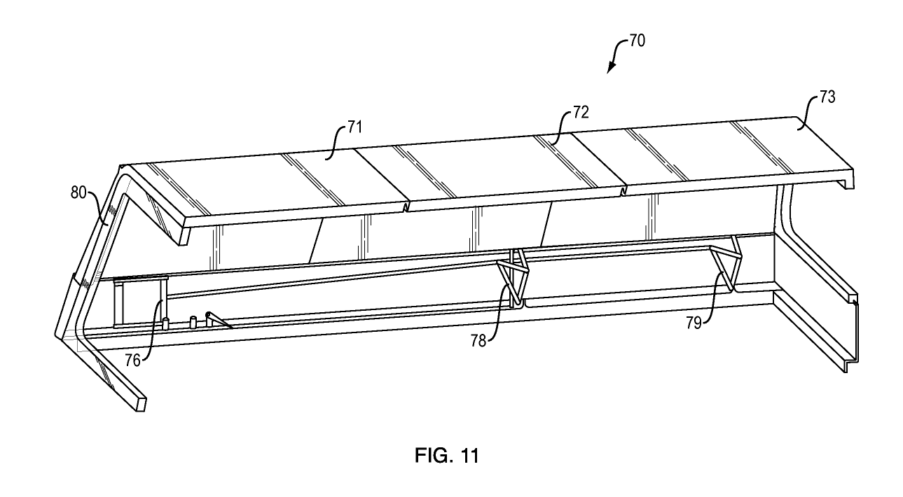

As seen in FIG. 9, segment 72 in turn is moved horizontally. As mentioned, horizontal displacement is provided manually by a user. Here, the full arrangement of bell crank actuators are visible as elements 74, 75, 76, 78, and 79. These elements then serve to raise the final segment 73 into place as shown in FIG. 10. In such configuration, the advantageously flat and contiguous surfaces are visible. FIG. 11 illustrates the insertion of a rear door 80 (shown in partial cutaway for illustrative clarity).

The segments and flanges may be fabricated from any material, though fiberglass composites are preferable due to their durable and corrosion-resistant nature. A variety of lighting element may also be integrated into the inventive truck cap. In such instance, an integrated tail light may be provided and prewired into the rear-most segment and/or the rear door. For ease of connection, wiring capable of integrating with existing truck cab lighting may be provided.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A modular truck cap, said cap comprising:
at least two segments forming a cover;
an actuation mechanism for retracting one of said at least two segments in a downward vertical motion while sliding another of said at least two segments in a horizontal motion.

2. The cap as claimed in claim 1 further including first and second side flanges, said side flanges each including a rail inset upon which said horizontal motion of said another of said at least two segment occurs.

3. The cap as claimed in claim 2 further including an interlocking seal between said at least two segments.

4. The cap as claimed in claim 3 wherein said interlocking seal provides a barrier upon coplanar placement of outer surfaces of said at least two segments.

5. The cap as claimed in claim 4 further including a removable rear door locatable in a deployed position upon coplanar placement of outer surfaces of said at least two segments and in a stored position upon retraction of said at least two segments.

6. The cap as claimed in claim 5 wherein said stored position is within said at least two segments when said at least two segments are nested upon one another.

7. The cap as claimed in claim 2 wherein each said segment includes a pair of ridges located at an exterior top location of each said segment, and at least two of said pair of ridges form sliding support for at least two of said segments.

8. A segmented modular truck cap for use in a cargo bed of a pickup truck, said cap comprising:
at least two segments arranged upon a flange and forming a cargo bed cover;
an actuation mechanism for actuation of said at least two segments between an extended position and a retracted position, said actuation mechanism capable of selectively
retracting one of said at least two segments in a downward vertical motion while another of said at least two segments move in a horizontal motion, and
extending one of said at least two segments in an upward vertical motion while another of said at least two segments moved in a horizontal motion.

9. The cap as claimed in claim 8 further including first and second side flanges within which said actuation mechanism is housed, said side flanges each including a rail inset upon which said another of said at least two segments is horizontally slidable.

10. The cap as claimed in claim 9 further including an interlocking seal formed at an edge between said at least two segments.

11. The cap as claimed in claim 10 wherein said interlocking seal provides a barrier impervious to wind, rain, snow, and road debris.

12. The cap as claimed in claim 11 wherein said interlocking seal is formed upon coplanar placement of outer surfaces of said at least two segments.

13. The cap as claimed in claim 12 further including a removable rear door locatable in a deployed position upon full extension of said at least two segments and in a stored position upon full retraction of said at least two segments.

14. The cap as claimed in claim 13 wherein said stored position is located under said at least two segments upon full retraction of said at least two segments.

15. The cap as claimed in claim 9 wherein each said segment includes a pair of ridges located at an exterior top location of each said segment, and at least two of said pair of ridges form sliding support for at least two of said segments.
